(19) United States
(12) Patent Application Publication
(10) Pub. No.: US 2007/0094028 A1
(43) Pub. Date: Apr. 26, 2007

(54) Portable device with speech-synthesizing and prelude functions

(75) Inventors: Yuan-Chia Lu, Taoyuan Hsien (TW); Jia-Lin She, Taoyuan Hsien (TW); Jian-Zhou Hung, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/454,576

(22) Filed: Jun. 16, 2006

(30) Foreign Application Priority Data
Oct. 21, 2005 (TW) 094136985

(51) Int. Cl. G10L 13/00

(52) U.S. Cl. 704/258

(57) ABSTRACT

A portable device providing a speech-synthesizing interface is provided. The portable device includes a portable main unit being inputted thereinto, storing and processing one of a text data and a music, transmitting a human voice data, receiving a command for one of the text data and the music, and at least includes a speech-synthesizing module converting the text data into the human voice data; and a wireless communication module connected with the speech-synthesizing module, wirelessly receiving the command and wirelessly transmitting one of the human voice data and the music; and at least one wireless headset wirelessly transmitting the command to the portable main unit and receiving and playing one of the human voice data and the music transmitted from the wireless communication module of the portable main unit within an effective receiving and transmitting range.

### FIELD OF THE INVENTION

The invention relates to a portable device, and more particularly to a portable device with the speech-synthesizing and prelude selection functions.

### BACKGROUND OF THE INVENTION

Nowadays, the wireless communication module equipped in the portable device has become a standard option. The user can operate the portable device in a wireless way. In other words, while using the portable device, the user won't need to watch the screen. In that sense, hearing becomes a practical communication means instead. Take the MP3 player as an example; if it is embedded with a bluetooth module and equipped with a bluetooth headset, the user can listen to the music wirelessly. However, the increasing capacity of the MP3 player allows hundreds or even thousands of songs to be stored in the MP3 player. If the user wants to select a song, he has to search the song by using the control keys to view the selections on the tiny screen song after song. Due to the cost concern, some portable devices even are not equipped with a screen. Besides, the size of the screen is also limited to that of the portable device. Moreover, it is strenuous for the user to watch those undersized characters on the screen. During the search, even though the song title is ascertained, the melody of the song stays unknown for the user until it has been played for a while. Therefore, such an interface is not a friendly one for the user.

Due to the progress of computer technology, the trend of combining the portable device with the wireless communication has become inevitable in the future. However, the major drawbacks of the portable device lies in its tiny size and the lack of suitable I/O devices. By and large, the speech is the most natural, direct and efficient way for human beings to interact with portable devices.

From the above description, it is known that how to develop an improved portable device has become a major problem to be solved. In order to overcome the drawbacks in the prior art, a portable device with the speech-synthesizing and prelude functions is provided. The particular design in the present invention not only solves the problems described above, but also is easy to be implemented. Thus, the invention has the utility for the industry.

### SUMMARY OF THE INVENTION

In accordance with a first aspect of the present invention, a portable device providing a speech-synthesizing interface is provided. The portable device includes a portable main unit being inputted thereinto, storing and processing one of a text data and a music, transmitting a human voice data, receiving a command for one of the text data and the music, and at least includes a speech-synthesizing module converting the text data into the human voice data; and a wireless communication module connected with the speech-synthesizing module, wirelessly receiving the command and wirelessly transmitting one of the human voice data and the music; and at least one wireless headset wirelessly transmitting the command to the portable main unit and receiving and playing one of the human voice data and the music transmitted from the wireless communication module of the portable main unit within an effective receiving and transmitting range.

Preferably, the portable main unit is an MP3 player.

Preferably, the portable main unit is a personal digital assistant (PDA).

Preferably, the text data is a text title.

Preferably, the text data is a text content.

Preferably, the wireless communication module is a bluetooth module.

Preferably, the wireless headset is a bluetooth headset.

In accordance with a second aspect of the present invention, a portable device providing a speech-synthesizing interface is provided. The device includes a portable main unit being inputted with, storing and processing one of a text data or a music, transmitting a human voice data, receiving a command for one of the text data and the music, and at least includes a wireless communication module wirelessly receiving the command and wirelessly transmitting one of the human voice data and the music; and at least one wireless headset wirelessly transmitting the command to the portable main unit and receiving and playing one of the text data and the music transmitted from the wireless communication module of the portable main unit within an effective receiving and transmitting range, at least including a speech-synthesizing module converting the text data into a human voice data played by the wireless headset.

Preferably, the portable main unit is an MP3 player.

Preferably, the portable main unit is a personal digital assistant (PDA).

Preferably, the text data is a text title.

Preferably, the text data is a text content.

Preferably, the wireless communication module is a bluetooth module.

Preferably, the wireless headset is a bluetooth headset.

In accordance with a third aspect of the present invention, a portable device providing one of a musical prelude selection function and a synthesized song title is provided. The portable device includes a portable main unit inputting therein, storing and processing a musical data and at least one marking of the musical data, transmitting a prelude data representing one of the musical data and the marking, receiving a command for one of the musical data and the prelude data, and at least includes a wireless communication module wirelessly receiving the command and wirelessly transmitting one of the musical data and the prelude data; and at least one wireless headset wirelessly transmitting the command to the portable main unit and receiving and playing one of the prelude data and the musical data transmitted from the wireless communication module of the portable main unit within an effective receiving and transmitting range.

Preferably, the marking includes a starting time index indicative of a time spot when to play the prelude data within the musical data, and a duration index indicative of a time period how long the prelude data is played.

Preferably, the marking is inputted by one of a pre-determined means and a user-defined means.

Preferably, the wireless communication module is a bluetooth module.

Preferably, the wireless headset is a bluetooth headset.

In accordance with a fourth aspect of the present invention, a portable main unit being inputted therewith, storing and processing one of a text data and a music is provided. The portable main unit includes a speech-synthesizeing module converting the text data into a human voice data, and a wireless communication module wirelessly receiving a command and wirelessly transmitting one of the human voice data and the music.

Preferably, the portable main unit is an MP3 player.

Preferably, the portable main unit is a personal digital assistant (PDA).

Preferably, the wireless communication module is a bluetooth module.

In accordance with a fifth aspect of the present invention, a wireless headset is provided. The wireless headset includes at least a key generating a command, and a speech-synthesizing module receiving a text data, converting the text data into a human voice data and playing the human voice data.

Preferably, the text data is a text title.

Preferably, the text data is a text content.

Preferably, the wireless headset is a bluetooth headset.

In accordance with a sixth aspect of the present invention, a portable main unit is provided. The portable main unit includes a database storing a plurality of musical data, and a wireless communication module wirelessly receiving a command and wirelessly transmitting one of the plurality of musical data and a plurality of markings representing a prelude data of the plurality of musical data.

Preferably, the marking includes a starting time index indicative of a time spot when to play the prelude data, and a duration index indicative of a time period how long the prelude data lasts is played.

Preferably, the marking is inputted by one of a pre-determined means and a user-defined means.

Preferably, the portable main unit is an MP3 player.

Preferably, the portable main unit is a personal digital assistant (PDA).

Preferably, the wireless communication module is a bluetooth module.

The foregoing and other features and advantages of the present invention will be more clearly understood through the following descriptions with reference to the drawing, wherein:

### BRIEF DESCRIPTION OF THE DRAWINGS

FIG. 1 is a schematic diagram showing the speech-synthesizing portable device according to a first preferred embodiment of the present invention;

FIG. 2 is a schematic diagram showing the speech-synthesizing portable device according to a second preferred embodiment of the present invention; and

FIG. 3 is a schematic diagram showing the musical data with the marking setup of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

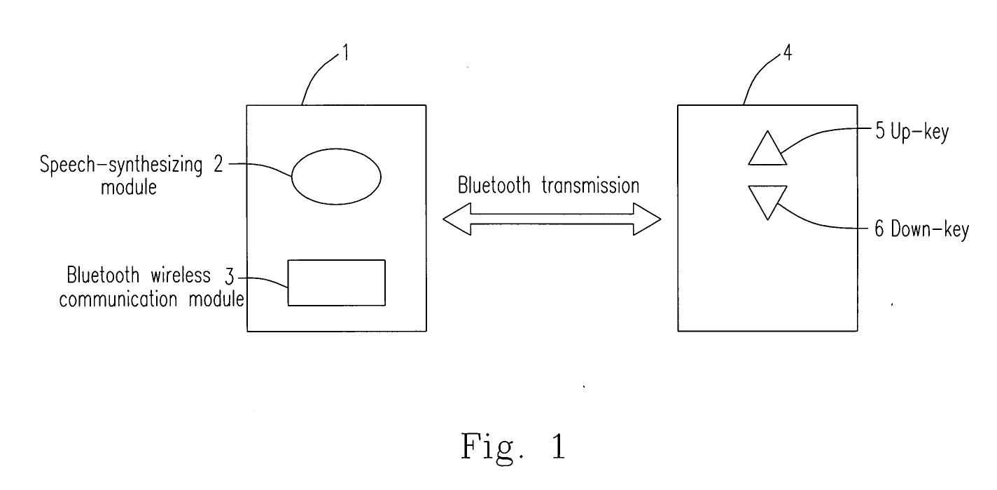

Please refer to FIG. 1, which is a schematic diagram showing the speech-synthesized portable device according to a first preferred embodiment of the present invention. In FIG. 1, a speech-synthesizing interface is provided which enables a portable main unit 1, when coupled with at least a bluetooth headset 4, to play the title of the selected text information with a synthesized human voice. For example, the portable main unit 1 can be an MP3 player, a PDA, etc., and the selected text information can be an e-mail, a news, etc. When the speech-synthesized does not have a screen or it is not convenient for the user to view the screen, the abstract of the text information to be searched is still accessible.

The first preferred embodiment contains the portable main unit 1 and the bluetooth headset 4. The portable main unit 1 is used to input, store and process the required text information, receive a command transmitted from the bluetooth headset 4, and transmit the converted human voice data of the text information corresponding to the command to the at least a bluetooth headset 4 in a Bluetooth transmission way. The portable main unit 1 further includes at least a speech-synthesizing module 2 and a bluetooth wireless communication module 3. The speech-synthesizing module 2 is used to convert the text information into the human voice data. The bluetooth wireless communication module 3 is connected with the speech-synthesizing module 2 for wirelessly receiving the command and wirelessly transmitting the human voice data to the bluetooth headset 4.

An up-key 5 and a down-key 6 are disposed on the bluetooth headset 4. Since the information is sequentially listed, the user can press the up-key 5 and the down-key 6 to choose the sequential data (like music). The user simply needs to press the up-key 5 or the down-key 6 to send commands to the speech-synthesizing module 2 and receive the synthesized human voice by the bluetooth headset 4, and then decides which information he wants thereby.

While the up-key 5 or the down-key 6 of the bluetooth headset 4 is pressed, the bluetooth headset 4 sends a signal to the portable main unit 1 to select the title of the corresponding text information. When the title of the corresponding text information is selected, the portable main unit 1 transmits the selected title to the speech-synthesizing module 2 so as to convert the selected title into a human voice data by means of a text and prosody processing. Next, the human voice data is transmitted to the bluetooth wireless communication module 3 and then to the bluetooth headset 4 in a bluetooth transmission way. After being received by the bluetooth headset 4, the human voice data is played in the form of a synthesized human voice. After the user understands the title, he can decide whether to stay with the text information to further listen to the synthesized human voice, or to press the up-key 5 or the down-key 6 to search for the previous or next information.

Actually, the portable main unit 1 is the main feature of the first preferred embodiment, while the bluetooth headset 4 is just an additional feature thereof.

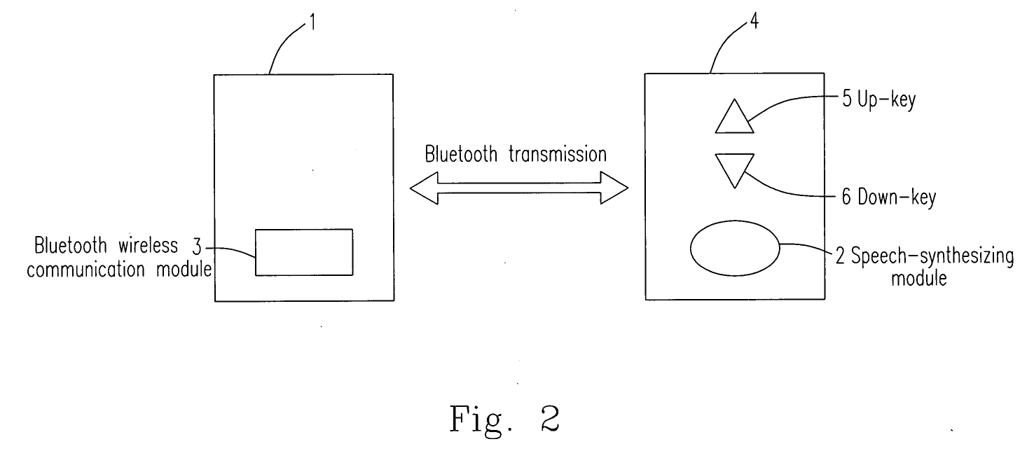

Please refer to FIG. 2, which is a schematic diagram showing the speech-synthesizing portable device according to a second preferred embodiment of the present invention. The second preferred embodiment contains a portable main unit 1 and at least a bluetooth headset 4. The portable main unit 1 is used to input, store and process the required text information, receive a command transmitted from the bluetooth headset 4, and transmit the text information corresponding to the command to the bluetooth headset 4 in a bluetooth transmission way. The portable main unit 1 further contains at least a bluetooth wireless communication module 3 for wirelessly receiving the command and wirelessly transmitting the specified text information to the bluetooth headset 4. The bluetooth headset 4 includes a speech-synthesizing module 2 for receiving the text information and converting it into the synthesized human voice to be played by the bluetooth headset 4.

When the up-key 5 or the down-key 6 of the bluetooth headset 4 is pressed, the bluetooth headset sends a signal to the portable main unit 1 to select the title of the corresponding text information. When the title of the corresponding text information is selected, the bluetooth wireless communication module 3 in the portable main unit 1 wirelessly transmits the title to the surrounding bluetooth headsets 4 in a bluetooth transmission way. After the bluetooth headset 4 receives the title, the title is converted into a human voice data by the speech-synthesizing module 2, and then the human voice data is played by the bluetooth headset 4. After the user understands the title, he can decide whether to stay with the text information to further listen to the synthesized human voice, or to press the up-key 5 or the down-key 6 to search for the previous or next information.

Actually, the bluetooth headset 4, the up-key 5 and the down-key 6 are the main features of the second preferred embodiment, while the portable main unit 1 is just an additional feature.

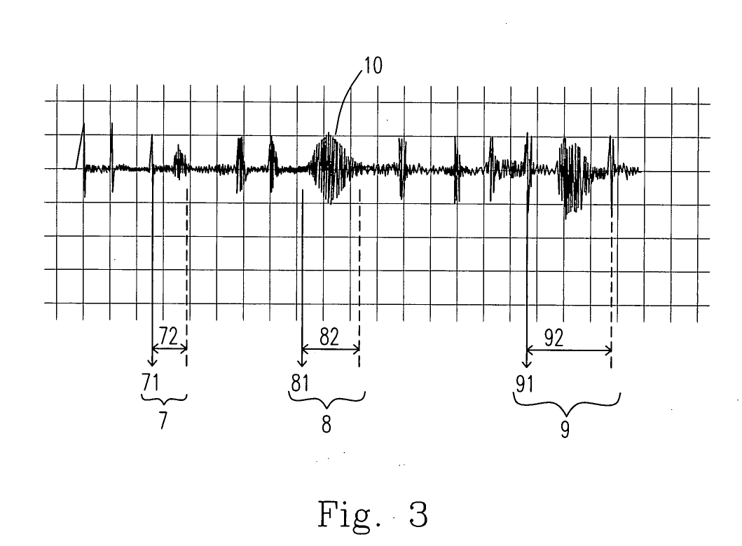

Please refer to FIG. 3 and FIG. 1 simultaneously. FIG. 3 is a schematic diagram showing the musical data with the marking setup of the present invention. The musical data 10 include a plurality of markings 7, 8 and 9. The marking 7 contains a starting time index 71 and a duration index 72 of a prelude, the marking 8 contains a starting time index 81 and a duration index 82 of a prelude, and the marking 9 contains a starting time index 91 and a duration index 92 of a prelude. The starting time index 71, 81 or 91 specifies a time spot in the musical data when the prelude starts playing. The prelude is stopped when the corresponding duration index 72, 82 or 92 is finished. A plurality of musical data are stored in a database (not shown) of the portable main unit 1 according to the aforementioned format.

Firstly, the user selects the operation mode. The first mode is to listen to the title of the synthesized song and the second mode is to listen to the musical prelude. If the first mode is selected, when the user presses the up-key 5 or the down-key 6 on the bluetooth headset 4 to select songs from the database, the titles of the selected songs are sequentially synthesized as human voice data. Then, the synthesized human voice data are transmitted to the bluetooth headset 4 via the bluetooth wireless communication module 3. If the second mode is selected, when the user presses the up-key 5 or the down-key 6 on the bluetooth headset 4 to select songs from the database, the access signal is transmitted from the bluetooth headset 4 to the portable main unit 1. After the bluetooth wireless communication module 3 of the portable main unit 1 receives the access signal, the portable main unit 1 retrieves the markings 7, 8 and 9 in the musical data 10 and the musical data 10 from the database in accordance with the access signal. The retrieved markings 7, 8 and 9 are converted into the corresponding prelude data, and then the corresponding prelude data are transmitted to the bluetooth wireless communication module 3. The corresponding prelude data are transmitted to the bluetooth headset 4. The bluetooth headset 4 immediately plays the corresponding prelude data after receiving them. During the playing of the corresponding prelude data, the user can decide whether to keep listening to the musical data 10, or to press the up-key 5 or the down-key 6 to stop playing the prelude data and continue to search for the required data.

Actually, the database in the portable main unit 1 and the bluetooth wireless communication module 3 are the main features of this preferred embodiment, while the bluetooth headset 4 is just an additional feature.

In sum, the present invention uses a speech-synthesizing module and the selection of the prelude of the musical data to provide a natural and humanized human-machine interface. The present invention provides synthesizd human voices representing different titles or the partial contents corresponding to the selected title so as to provide a convenient, fast and clear interface for searching massive data stored in the portable device. Therefore, the present invention effectively solves the problems and drawbacks in the prior art, and thus it fits the demand of the industry and is industrially valuable.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A portable device providing a speech-synthesizing interface, comprising:
a portable main unit being inputted thereinto, storing and processing one of a text data and a music, transmitting a human voice data, receiving a command for said one of said text data and said music, and at least comprising:
a speech-synthesizing module converting said text data into said human voice data; and
a wireless communication module connected with said speech-synthesizing module, wirelessly receiving said command and wirelessly transmitting said one of said human voice data and said music; and
at least one wireless headset wirelessly transmitting said command to said portable main unit and receiving and playing said one of said human voice data and said music transmitted from said wireless communication module of said portable main unit within an effective receiving and transmitting range.

2. The portable device of claim 1, wherein said portable main unit is an MP3 player.

3. The portable device of claim 1, wherein said portable main unit is a personal digital assistant (PDA).

4. The portable device of claim 1, wherein said text data is a text title.

5. The portable device of claim 1, wherein said text data is a text content.

6. The portable device of claim 1, wherein said wireless communication module is a bluetooth module.

7. The portable device of claim 1, wherein said wireless headset is a bluetooth headset.

8. A portable device providing a speech-synthesizing interface, comprising:
a portable main unit being inputted with, storing and processing one of a text data or a music, transmitting a human voice data, receiving a command for said one of said text data and said music, and at least comprising:
a wireless communication module wirelessly receiving said command and wirelessly transmitting said one of said human voice data and said music; and
at least one wireless headset wirelessly transmitting said command to said portable main unit and receiving and playing said one of said text data and said music transmitted from said wireless communication module of said portable main unit within an effective receiving and transmitting range, at least comprising a speech-synthesizing module converting said text data into a human voice data played by said wireless headset.

9. The portable device of claim 8, wherein said portable main unit is an MP3 player.

10. The portable device of claim 8, wherein said portable main unit is a personal digital assistant (PDA).

11. The portable device of claim 8, wherein said text data is a text title.

12. The portable device of claim 8, wherein said text data is a text content.

13. The portable device of claim 8, wherein said wireless communication module is a bluetooth module.

14. The portable device of claim 8, wherein said wireless headset is a bluetooth headset.

15. A portable device providing one of a musical prelude selection function and a synthesized song title, comprising:
a portable main unit inputting therein, storing and processing a musical data and at least one marking of said musical data, transmitting a prelude data representing said one of said musical data and said marking, receiving a command for said one of said musical data and said prelude data, and at least comprising:
a wireless communication module wirelessly receiving said command and wirelessly transmitting said one of said musical data and said prelude data; and
at least one wireless headset wirelessly transmitting said command to said portable main unit and receiving and playing said one of said prelude data and said musical data transmitted from said wireless communication module of said portable main unit within an effective receiving and transmitting range.

16. The portable device of claim 15, wherein said marking comprises a starting time index indicative of a time spot when to play said prelude data within said musical data, and a duration index indicative of a time period how long said prelude data is played.

17. The portable device of claim 15, wherein said marking is inputted by one of a pre-determined means and a user-defined means.

18. The portable device of claim 15, wherein said wireless communication module is a bluetooth module.

19. The portable main unit of claim 15, wherein said wireless headset is a bluetooth headset.

20. A portable main unit being inputted therewith, storing and processing one of a text data and a music, comprising:
a speech-synthesizing module converting said text data into a human voice data; and
a wireless communication module wirelessly receiving a command and wirelessly transmitting said one of said human voice data and said music.

21. The portable main unit of claim 20 being an MP3 player.

22. The portable main unit of claim 20 being a personal digital assistant (PDA).

23. The portable main unit of claim 20, wherein said wireless communication module is a bluetooth module.

24. A wireless headset, comprising:
at least a key generating a command; and
a speech-synthesizing module receiving a text data, converting said text data into a human voice data and playing said human voice data.

25. The wireless headset of claim 24, wherein said text data is a text title.

26. The wireless headset of claim 24, wherein said text data is a text content.

27. The wireless headset of claim 24, wherein said wireless headset is a bluetooth headset.

28. A portable main unit, comprising:
a database storing a plurality of musical data; and
a wireless communication module wirelessly receiving a command and wirelessly transmitting one of said plurality of musical data and a plurality of markings representing a prelude data of said plurality of musical data.

29. The portable main unit of claim 28, wherein said marking comprises a starting time index indicative of a time spot when to play said prelude data, and a duration index indicative of a time period how long said prelude data lasts is played.

30. The portable main unit of claim 28, wherein said marking is inputted by one of a pre-determined means and a user-defined means.

31. The portable main unit of claim 28 being an MP3 player.

32. The portable main unit of claim 28 being a personal digital assistant (PDA).

33. The portable main unit of claim 28, wherein said wireless communication module is a bluetooth module.
